(19) United States
(12) Patent Application Publication
(10) Pub. No.: US 2006/0093824 A1
(43) Pub. Date: May 4, 2006

(54) Resin composition and its use

(76) Inventor: Mitsuru Nozaki, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/251,934

(22) Filed: Oct. 18, 2005

(30) Foreign Application Priority Data
Oct. 28, 2004 (JP) 2004-313562

(51) Int. Cl. C08K 5/34; B32B 9/04

(52) U.S. Cl. 428/411.1; 428/473.5; 524/86

(57) ABSTRACT

A thermosetting resin composition containing a cyanate ester resin (a) having at least two cyanate groups per molecule, a bismaleimide (b) represented by the formula (1) 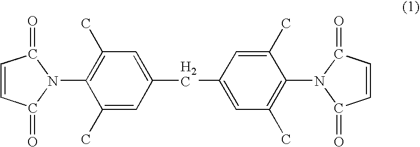
wherein each of R₁, R₂, R₃, and R₄ is independently an alkyl group having 3 or less carbon atoms, and a bismaleimide (c) represented by the formula (2), 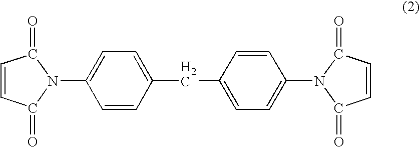 a copper-clad laminate comprising the above thermosetting resin composition and a printed wiring board comprising the above copper-clad laminate.

### FIELD OF THE INVENTION

The present invention relates to a specific cyanate ester-bismaleimide resin composition which is capable of shortening a curing time and decreasing a curing temperature, a copper-clad laminate using the above resin composition and a printed wiring board using the above copper-clad laminate. The above resin composition has excellent properties such as dielectric constant and heat resistance after moisture absorption so that it is suited for use in a copper-clad laminate, a printed wiring board, a casting resin, etc.

### BACKGROUND OF THE INVENTION

Cyanate ester resins have been known as a thermosetting resin excellent in high heat resistance and dielectric characteristics. Resin compositions (for example, JP-B-54-30440) using the above cyanate ester resin in combination with a bismaleimide resin are called BT resins. In recent years, these BT resins are widely used for materials for high-function printed wiring boards, such as a semiconductor plastic package. Resin compositions which use a general bismaleimide compound as a bismaleimide compound of the BT resin have excellent properties in view of high heat resistance, chemical resistance, mechanical properties, electric properties and soldering heat resistance, while further improvements are required in view of heat resistance after moisture absorption and dielectric constant. As a means for satisfying these properties, a resin composition using a specific bismaleimide compound having an alkyl group in a side chain of a benzene nucleus is disclosed (for example, JP-A-7-53864). However, although this cyanate ester-bismaleimide resin composition has excellent properties in view of dielectric constant and heat resistance after moisture absorption, the reactivity is low so that it is required to cure it under heat at a high temperature for a long time. For this reason, a limitation is imposed on productivity so that further improvement is required.

### SUMMARY OF THE INVENTION

It is an object of the present invention to make an improvement in the productivity of a specific cyanate ester-bismaleimide resin composition such as reduction in curing time and a decrease in curing temperature for overcoming the above problems.

It is another object of the present invention to provide a thermosetting resin composition having excellent properties in view of dielectric constant and heat resistance after moisture absorption.

According to the present invention, there is provided a thermosetting resin composition containing a cyanate ester resin (a) having at least two cyanate groups per molecule, a bismaleimide (b) represented by the formula (1),

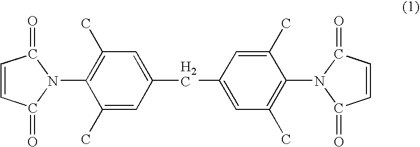

wherein each of R₁, R₂, R₃, and R₄ is independently an alkyl group having 3 or less carbon atoms, and a bismaleimide (c) represented by the formula (2),

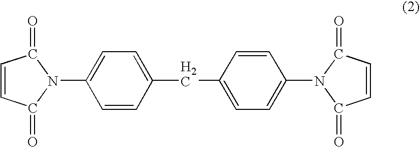

According to the present invention, there is further provided a thermosetting resin composition according to the above resin composition, wherein the weight ratio between the cyanate ester resin (a) and the bismaleimide compounds {(b)+(c)} is preferably from 70:30 to 30:70.

According to the present invention, there is still further provided a thermosetting resin composition according to the above resin composition, wherein the weight ratio between the bismaleimide (b) and the bismaleimide (c) is preferably from 95:5 to 70:30.

According to the present invention, there are furthermore provided a copper-clad laminate using the above thermosetting resin and a printed wiring board using the above copper-clad laminate.

### EFFECT OF THE INVENTION

The thermosetting resin composition of the present invention has actualized an improvement in the reactivity of specific cyanate ester-bismaleimide resin composition and accordingly the productivity can be remarkably improved. In addition, a cured product obtained from the resin composition of the present invention has excellent properties in view of dielectric constant and heat resistance after moisture absorption so that it overcomes weak points of a conventional cyanate ester-bismaleimide resin composition. Therefore, its industrial significance is remarkably great.

### DETAILED DESCRIPTION OF THE INVENTION

The present invention has been completed by finding, as a result of diligent studies for achieving the above objects, that the use of a specific cyanate ester-bismaleimide resin composition in combination with a specific bismaleimide can increase reactivity and also provide a thermosetting resin composition having excellent properties in view of dielectric constant and heat resistance after moisture absorption.

The cyanate ester resin (a) used in the present invention is not specially limited so long as it is a compound having at least two cyanate groups per molecule. Specific examples thereof include 1,3- or 1,4-dicyanatobenzene, 1,3,5-tricyanatobenzene, 1,3-, 1,4-, 1,6-, 1,8-, 2,6- or 2,7-dicyanatonaphthalene, 1,3,6-tricyanatonaphthalene, 4,4-dicyanatobiphenyl, bis(4-cyanatophenyl)methane, bis(3,5-dimethyl-4-cyanatophenyl)methane, 2,2-bis(4-cyanatophenyl)propane, 2,2-bis(3,5-dibromo-4-cyanatophenyl)propane, 2,2-bis(3,5-dimethyl-4-cyanatophenyl)propane, bis(4-cyanatophenyl)ether, bis(4-cyanatophenyl)thioether, bis(4-cyanatophenyl) sulfone, tris (4-cyanatophenyl)phosphite, tris(4-cyanatophenyl)phosphate, cyanate esters obtained by a reaction of an oligomer, etc., of novolak or a hydroxyl-group-containing thermoplastic resin, such as hydroxypolyphenylene ether, hydroxypolystyrene, hydroxypolycarbonate, etc., with a cyanogen halide, a cyanate ester (Japanese Kohyo No. 61-501094) obtained by a reaction of a polyfunctional phenol having phenols bonded with dicyclopentadiene with a cyanogen halide, and cyanate esters disclosed in JP-B-41-1928, JP-B-43-18468, JP-B-44-4791, JP-B-45-11712, JP-B-46-41112, JP-B-47-26853and JP-A-51-63149, etc. These cyanate ester resins may be used alone or in combination, as required.

The cyanate ester resin (a) is preferably 1,3- or 1,4-dicyanatobenzene, 1,3,5-tricyanatobenzene, bis(3,5-dimethyl-4-cyanatophenyl)methane, bis(4-cyanatophenyl)methane, 2,2-bis(4-cyanatophenyl)propane or phenol novolak cyanate. Further, prepolymers having a triazine ring formed by trimerization of cyanate groups of any one of these cyanate esters and having a molecular weight of 400 to 6,000 are preferably used. The above prepolymer is obtained by polymerizing the above cyanate ester monomer in the presence of an acid such as a mineral acid or a Lewis acid; a base such as sodium alcoholate or a tertiary amine; or a salt such as sodium carbonate as a catalyst.

The bismaleimide (b) used in the present invention is not specially limited so long as it is a bismaleimide compound represented by the formula (1). Preferred examples thereof include bis(3,5-dimethyl-4-maleimidephenyl)methane, bis(3-ethyl-5-methyl-4-maleimidephenyl)methane and bis(3,5-diethyl-4-maleimidephenyl)methane. These bismaleimides (b) maybe used alone or in combination as required. Further, there may be used a prepolymer of the bismaleimide (b) or a prepolymer of the bismaleimide (b) and an amine compound.

The bismaleimide (c) used in the present invention refers to a bismaleimide compound represented by the formula (2) and generally obtained by reacting diaminodiphenyl methane with maleic anhydride. There may be used a prepolymer of the bismaleimide (c) and a prepolmer of the bismaleimide (C) and an amine compound. The weight ratio of the cyanate ester resin (a): the bismaleimide compounds {(b)+(c)} is from 70:30 to 30:70, preferably 60:40 to 40:60. Further, the weight ratio of the bismaleimide (b): the bismaleimide (c) is from 95:5 to 70:30, preferably 90:10 to 80:20.

In the present invention, the method for preparing the resin composition containing the cyanate ester resin (a), the bismaleimide (b) and the bismaleimide (c) is not specially limited. For example, the cyanate ester resin (a), the bismaleimide (b) and the bismaleimide (c) may be simply melt-blended or may be mixed after dissolving the cyanate ester resin (a), the bismaleimide (b) and the bismaleimide (c) in an organic solvent such as methyl ethyl ketone, N-methyl pyrolidone, dimethylformamide, dimethylacetamide, toluene or xylene. Further, the cyanate ester resin (a), the bismaleimide (b) and the bismaleimide (c) may be mixed after converting at least one selected from the cyanate ester resin (a), the bismaleimide (b) and the bismaleimide (c) into oligomer(s). Moreover, it is possible to mix at least two selected from the cyanate ester resin (a), the bismaleimide (b) and the bismaleimide (c)and then convert them into oligomers.

An epoxy resin is preferably used in combination with the thermosetting resin composition of the present invention. The epoxy resin used can be selected from known epoxy resins. Specific examples thereof include a bisphenol A type epoxy resin, a bisphenol F type epoxy resin, a phenol novolak type epoxy resin, a cresol novolak type epoxy resin, a bisphenol A novolak type epoxy resin, a trifunctional or tetrafunctional phenol type epoxy resin, a naphthalene type epoxy resin, a biphenyl type epoxy resin, a phenol aralkyl type epoxy resin, a biphenyl aralkyl type epoxy resin, a naphthol aralkyl type epoxy resin, and nuclear brominated epoxy resins of these epoxy resins; phosphorus-containing epoxy resins obtained by a reaction of a phosphorus-containing compound with an epoxy resin or epichlorohydrin; an alicyclic epoxy resin, a polyol type epoxy resin, glycidyl amine, glycidyl ester; compounds obtained by epoxidation of a double bond such as butadiene; and compounds obtained by a reaction of a hydroxyl-group-containing silicon resin with epichlorohydrin. These epoxy resins maybe used alone or in combination, as required.

The thermosetting resin composition of the present invention undergoes curing itself under heat, while a known curing catalyst or a known curing accelerator may be incorporated for the purpose of accelerating the curing. Examples of such compounds include organic peroxides such as benzoyl peroxide, lauroyl peroxide, acetyl peroxide, parachlorobenzoyl peroxide and di-tert-butyl-di-perphthalate; azo compounds such as azobisnitrile; imidazoles such as 2-methylimidazole, 2-undecylimidazole, 2-phenylimidazole, 2-ethyl-4-methylimidazole, 1-benzyl-methylimidazole, 1-cyanoethyl-2-methylimidazole, 1-cyanoethyl-2-ethylimidazole, 1-cyanoethyl-2-undecylimidazole, 1-cyanoethyl-2-phenylimidazole, 1-cyanoethyl-2-ethyl-methylimidazole and 1-guanaminoethyl-2-methylimidazole, carboxylic acid adducts of these imidazoles and carboxylic anhydride adducts of these imidazoles; tertiary amines such as N,N-dimethylbenzylamine, N,N-dimethylaniline, N,N-dimethyltoluidine, 2-N-ethylanilinoethanol, tri-n-butylamine, pyridine, quinoline, N-methylmorpholine, triethanolamine, triethylenediamine, tetramethylbutanediamine and N-methylpiperidine; phenols such as phenol, xylenol, cresol, resorcin and catechol; organic metal salts such as lead naphthenate, lead stearate, zinc naphthenate, zinc octylate, tin oleate, dibutyltin maleate, manganese naphthenate, cobalt naphthenate and acetylacetone iron; materials obtained by dissolving any one of these organic metals in a hydroxyl-group-containing compound such as phenol or bisphenol; inorganic metal salts such as tin chloride, zinc chloride and aluminum chloride; organotin compounds such as dioctyltin oxide, other alkyltin and alkyltin oxide; and acid anhydrides such as maleic anhydride, phthalic anhydride, anhydrous lauril acid, pyromellitic anhydride, trimellitic anhydride, hexahydrophthalic anhydride, hexahydrotrimellitic anhydride, and hexahydropyromellitic anhydride. The curing catalyst or the curing accelerator may be added in a general amount. For example, the amount of the curing catalyst or the curing accelerator based on the thermosetting resin composition is 10 wt % or less, generally about 0.01 to 2 wt %.

The thermosetting resin composition of the present invention may further contain a variety of additives so long as the inherent properties of the resin composition are not impaired. These additives include natural or synthetic resins, an inorganic or organic fibrous reinforcing material or an inorganic or organic filler. These additives may be properly used in combination, as required. Examples of the natural or synthetic resins include polyimide; polyvinyl acetal; aphenoxy resin; an acrylic resin; an acrylic resin having a hydroxyl group or a carboxylic group; a silicon resin; an alkyd resin; a thermoplastic polyurethane resin; polybutadiene, a butadiene-acrylonitrile copolymer; elastomers such as polychloroprene, a butadiene-styrene copolymer, polyisoprene, butyl rubber, fluoro rubber and natural rubber; styrene-isoprene rubber, acrylic rubber, core shell rubbers of these; epoxidized butadiene, maleated butadiene; vinyl compound polymers such as polyethylene, polypropylene, a polyethylene-propylene copolymer, poly-4-methylpentene-1, polyvinyl chloride, polyvinylidene chloride, polystyrene, polyvinyl toluene, polyvinyl phenol, AS resin, ABS resin, MBS resin, poly-4-fluoroethylene, a fluoroethylene-propylene copolymer, 4-fluoroethylene-6-fluoroethylene copolymer and vinylidene fluoride; thermoplastic resins such as polycarbonate, polyester carbonate, polyphenylene ether, polysulfone, polyester, polyether sulfone, polyamide, polyamide imide, polyester imide and polyphenylene sulfite, and low-molecular-weight polymers of these; poly(meth)acrylates such as (meth)acrylate, epoxy(meth)acrylate and di(meth)acryloxy-bisphenol; polyallyl compounds such as styrene, vinylpyrrolidone, diacryl phthalate, divinylbenzene, diallyl benzene, diallyl ether bisphenol and trialkenyl isocyanurate, and prepolymers thereof; dicyclopentadiene and prepolymers thereof; a phenol resin; monomers containing a polymerizable double bond such as an unsaturated polyester, and prepolymers thereof; curable monomers or prepolymers such as polyisocyanates.

Examples of the inorganic or organic fibrous reinforcing material include inorganic fibers such as glass fibers typified by E, NE, D, S and T glasses, a silica glass fiber, a carbon fiber, an alumina fiber, a silicon carbide fiber, asbestos, rockwool, slag wool and plaster whisker, woven fabrics or non-woven fabrics thereof, or mixtures of these; organic fibers such as a wholly aromatic polyamide fiber, a polyimide fiber, a liquid crystal polyester,a polyester fiber, a fluorine fiber, a polybenzoxazole fiber, cotton, linen and a semi-carbon fiber, woven fabrics or non-woven fabrics thereof, or mixtures of these; combined woven fabrics such as a glass fiber with a wholly polyamide fiber, a glass fiber with a carbon fiber, a glass fiber with a polyamide fiber, and a glass fiber with a liquid crystal aromatic polyester; inorganic papers such as glass paper, mica paper and alumina paper; kraft paper, cotton paper, paper-glass combined paper, etc., and mixed fibrous reinforcing materials properly composed of at least two members of the above materials. These materials are preferably subjected to a known surface-treatment for improving the adhesion to a resin. Further, a polyimide film, a wholly aromatic polyamide film, a polybenzoxazole film or a liquid crystal polyester film may be used for a thin material.

Examples of the inorganic or organic filler include silica, fused silica, synthesized silica, spherical silica, talc, calcined talc, kaolin, wollastonite, aluminum hydroxide, non-alkali glass, molten glass, silicon carbide, alumina, aluminum nitride, silica alumina, boron nitride, titanium oxide, wollastonite, mica, synthesized mica, plaster, calcium carbonate, magnesium carbonate, magnesium hydroxide and magnesium oxide. These fillers can be properly used in combination, as required. Further, various additives such as a dye, a pigment, a thickener, a lubricant, an antifoamer, a dispersing agent, a leveling agent, a photosensitizer, a flame retardant, a brightener, a polymerization inhibitor and a thixotropic agent may be used alone or in combination as required.

The curing condition for the thermosetting resin composition of the present invention varies depending on the constituent ratio of the resin composition, the presence or absence of the curing catalyst or curing accelerator, etc. For gelation or preliminary curing, it is possible to use a temperature of 100° C. or lower by selecting the curing catalyst or curing accelerator. For complete curing, the resin composition of the present invention is heated at a temperature properly selected in the range of generally 100° C. to 300° C. for a predetermined period of time, to obtain a cured product. In this case, the pressure level is not specially limited, while it is generally preferable to apply a pressure. Generally, the pressure is properly selected in the range of 0.01 to 50 MPa, preferably 0.5 to 15 MPa. The thermosetting resin composition of the present invention is used for various applications owing to its excellent physical properties and workability. For example, it is suitably used for a material for a printed wiring board such as prepreg or a copper-clad laminate, a structural material and a casting resin.

### EXAMPLES

The present invention will be specifically explained with reference to Examples and Comparative Examples hereinafter. In the Examples and Comparative Examples, “part” stands for “part by weight”.

### Examples 1 to 4 and Comparative Examples 1 and 2

2,2-bis(4-cyanatophenyl)propane(CX, supplied by Mitsubishi Gas Chemical Company, Inc.), bis(3-ethyl-5-methyl-4-maleimidephenyl)methane (BMI-70, supplied by K I KASEI KK) and bis(4-maleimidephenyl)methane (BMI-H, supplied by K I KASEI KK) were melt-blended in amounts shown in Table 1 at 150° C. for 20 minutes, and the melt-blended mixture was poured into a casting mold, defoamed under vacuum at 150° C. for 15 minutes and then cured under heat at 200° C. for 8 hours, to obtain a cured product having a thickness of 4 mm. Table 1 shows the measurement results of the physical properties of the cured product.

TABLE 1

| | | | | | Comparative | |
|---|---|---|---|---|---|---|
| | Example | | | | Example | |
| | 1 | 2 | 3 | 4 | 1 | 2 |
| CX (part by | 70 | 70 | 50 | 50 | 70 | 50 |
| weight) | | | | | | |
| BMI-70 (part by | 28.5 | 27 | 47.5 | 35 | 30 | 50 |
| weight) | | | | | | |
| BMI-H (part by | 1.5 | 3 | 2.5 | 15 | — | — |
| weight) | | | | | | |
| Glass transition | 219 | 229 | 210 | 242 | 161 | 151 |
| temperature (° C.) | | | | | | |

### Examples 5 to 7

2,2-bis(4-cyanatophenyl)propane(CX), bis(3-ethyl-5-methyl-4-maleimidephenyl)methane (BMI-70) and bis(4-maleimidephenyl)methane (BMI-H) were molten in amounts shown in Table 2 at 160° C. and allowed to react for 6 hours with stirring, to obtain an oligomer resin composition. The thus-obtained resin composition was dissolved in methyl ethyl ketone to obtain a varnish having a resin solid content of 60%. 0.05 part of zinc octylate and 0.5 part of dicumyl peroxide were added to the varnish, and the resultant mixture was uniformly blended to obtain a solution. The solution was impregnated into a plain-weave E glass woven fabric (116H, supplied by Nitto Boseki Co., Ltd.) having a thickness of 0.1 mm and then B-staged by drying at 150° C. for 6 minutes to obtain prepregs. Six said prepregs were stacked, electrolytic copper foils (3EC foil, Mitsui Mining and Smelting Co., Ltd.) having a thickness of 18 μm each were placed on the upper and lower surfaces of the stacked prepregs, one copper foil on the upper surface and the other on the lower surface, and the resultant set was laminate-molded at 200° C. at a pressure of 3 MPa for 120minutes, to obtain a copper-clad laminate having a thickness of 0.6 mm. Table 2 shows the measurement results of the physical properties of the copper-clad laminate.

### Example 8

40 parts of 2,2-bis (4-cyanatophenyl)propane (CX), 32 parts of bis(3-ethyl-5-methyl-4-maleimidephenyl)methane (BMI-70) and 8 parts of bis (4-maleimidephenyl)methane (BMI-H) were molten at 160° C. and allowed to react for 6 hours with stirring, to obtain an oligomer resin composition. 20 parts of a bisphenol A type epoxy resin (Epikote 1001, Japan Epoxy Resins Co., Ltd.) was added to the above resin composition and the mixture was dissolved in methyl ethyl ketone, to obtain a varnish having a resin content of 60%. Thereafter, a copper-clad laminate was obtained in the same manner as in Example 5 except that the above varnish was used. Table 2 shows the measurement results of the physical properties of the copper-clad laminate.

### Comparative Example 3 and 4

A copper-clad laminate having a thickness of 0.6 mm was obtained in the same manner as in Example 5 except that 2,2-bis(4-cyanatophenyl)propane (CX) and bis(3-ethyl-5-methyl-4-maleimidephenyl)methane (BMI-70) were molten at 160° C. and allowed to react for 10 hours with stirring. Table 2 shows the measurement results of the physical properties of the copper-clad laminate.

TABLE 2
Part: Part by weight

| | | | | | | Comparative | |
|---|---|---|---|---|---|---|---|
| | | Example | | | | Example | |
| | | 5 | 6 | 7 | 8 | 3 | 4 |
| CX (part) | | 70 | 50 | 50 | 40 | 70 | 50 |
| BMI-70 (part) | | 27 | 40 | 35 | 32 | 30 | 50 |
| BMI-H (part) | | 3 | 10 | 15 | 8 | — | — |
| Epikote 1001 (part) | | — | — | — | 20 | — | — |
| Glass transition | | 221 | 229 | 235 | 212 | 162 | 153 |
| temperature (° C.) | | | | | | | |
| Dielectric constant | | 3.7 | 3.6 | 3.9 | 4.3 | 3.9 | 3.7 |
| Heat resistance | 1 hour | ◯◯◯ | ◯◯◯ | ◯◯◯ | ◯◯◯ | ◯◯◯ | ◯◯◯ |
| after moisture | 3 hours | ◯◯◯ | ◯◯◯ | ◯◯◯ | ◯◯◯ | XXX | XXX |
| absorption | 5 hours | ◯◯◯ | ◯◯◯ | ◯◯◯ | ◯◯◯ | XXX | XXX |

| | | | | | | |
|---|---|---|---|---|---|---|
| Soldering | ◯◯◯ | ◯◯◯ | ◯◯◯ | ◯◯◯ | ◯◯X | ◯XX |
| heat resistance | | | | | | |
| Copper foil adhesive | 1.3 | 1.2 | 1.1 | 1.4 | 0.9 | 0.7 |
| strength (kgf/cm) | | | | | | |

(Measurement Methods)

1) Glass Transition Temperature:

A sample having a size of 4 mm×4 mm×4 mm (0.6 mm in the case of laminates) was measured three times with a TMA device (TA Instrumen type 2940) at a loading of 5 g at a temperature-increasing rate of 5° C./min, to obtain an average value.

2) Dielectric Constant:

A sample having a size of 100 mm×1 mm×0.6 mm was measured three times with a network analyzer HP8722ES (supplied by Agilent Technologies) according to a cavity resonance perturbation method, to obtain an average value (measurement frequency: 1 GHz).

3) Heat Resistance After Moisture Absorption:

The entire copper foil of a 50 mm×50 mm square sample other than a copper foil on the half of one surface of the sample was removed by etching. The sample was treated with a pressure cooker testing machine (PC-3 type, supplied by Hirayama Manufacturing Corporation) at 121° C. at 2 atmospheric pressure for a predetermined time, and then the sample was allowed to float in a solder bath at 260° C. for 60 seconds in accordance with JIS C6481, to check the presence or absence of a defective condition of appearance change by visual observation. (O: no defective condition, X: swelling or peeling occurred).

4) Soldering Heat Resistance:

A sample was allowed to float in a solder bath at a solder bath temperature of 260° C. for 60 seconds in accordance with JIS C6481, to check the presence or absence of a defective condition of appearance change by visual observation. (O: no defective condition, X: swelling or peeling occurred).

5) Copper Foil Adhesive Strength:

Measured three times according to JIS C6481, to obtain an average value.

What is claimed is:

1. A thermosetting resin composition containing a cyanate ester resin (a) having at least two cyanate groups per molecule, a bismaleimide (b) represented by the formula (1), 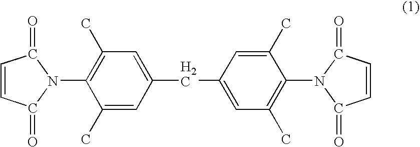
wherein each of R₁, R₂, R₃, and R₄ is independently an alkyl group having 3 or less carbon atoms, and a bismaleimide (c) represented by the formula (2),

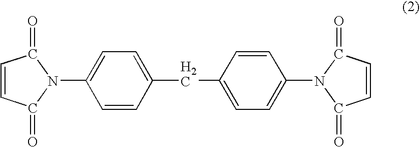

2. A thermosetting resin composition according to claim 1, wherein the weight ratio between the cyanate ester resin (a) and the bismaleimide compounds {(b)+(c)} is from 70:30 to 30:70.

3. A thermosetting resin composition according to claim 1, wherein the weight ratio between the bismaleimide (b) and the bismaleimide (c) is from 95:5 to 70:30.

4. A copper-clad laminate comprising the thermosetting resin composition recited in claim 1.

5. A printed wiring board comprising the copper-clad laminate recited in claim 4.
